(19) United States
(12) Patent Application Publication
(10) Pub. No.: US 2026/0288187 A1
(43) Pub. Date: Sep. 24, 2026

(54) Self-Biased Voltage Reference Generators

(71) Applicant: Apple Inc., Cupertino, CA (US)

(72) Inventors: Enrico Pardi, Pisa (IT); Maicol Cannella, Livorno (IT)

(21) Appl. No.: 19/085,447

(22) Filed: Mar. 20, 2025

(51) Int. Cl. G05F 3/26; G05F 1/575

(52) U.S. Cl. CPC G05F 3/262; G05F 1/575

(57) ABSTRACT

A system for generating a voltage reference may include a feedback path coupled to a first power rail, a reference circuit coupled to a second power rail, an output transistor, and a feedback transistor. The output transistor operates as switch during a first time to connect the first power rail to the voltage reference, then operates in saturation during a second time to regulate the voltage reference to a target voltage set by the reference circuit based on the feedback path driving the gate of the output transistor via a resistance. Other aspects are also described and claimed.

### BACKGROUND

### Field

This disclosure relates generally to voltage systems and, more specifically, to self-biased voltage reference generators for generating voltage references for system circuitry. Other aspects are also described.

### Background Information

In electronic systems, it may be necessary to generate voltage references. A voltage reference refers to a constant voltage level produced by a voltage reference generator on a voltage rail. A voltage reference is generally fixed to a constant voltage level, regardless of power supply variations, temperature changes, or aging. A voltage reference may be a positive voltage generated from a positive power rail or source or a negative voltage generated from a negative power rail or source.

A voltage reference may be generated to bias system circuitry, such as voltage regulators, power supplies, battery chargers, etc. For example, a buck converter, one type of commonly used voltage regulator, may control a power switch based on a comparison of an output voltage of the buck converter to the reference voltage. The system circuitry, e.g., the buck converter, in turn may provide power to enable further operation of downstream circuitry, such as logic gates of functional blocks of a system on a chip (SoC).

### SUMMARY

Implementations of this disclosure include switching an output transistor to clamp a power rail to a voltage reference upon start up to enable the voltage reference to quickly ramp with the power rail, then utilizing a feedback path to bias the output transistor in saturation to clamp the voltage reference to a target voltage. In some implementations, a system for generating a voltage reference may include a feedback path coupled to a first power rail, a reference circuit coupled to a second power rail, an output transistor, and a feedback transistor. The output transistor may operate as switch during a first time to connect the first power rail to the voltage reference. The output transistor may then operate in saturation during a second time to regulate the voltage reference to the target voltage set by the reference circuit. The output transistor may operate to regulate the voltage reference to the target voltage during the second time based on feedback to the feedback path driving the gate of the output transistor via a resistance coupled to the second power rail. As a result, the voltage reference may be available sooner to system circuitry, including at a lower voltage level of the power rail than in previous systems, to avoid delays to start system circuitry and/or to avoid unwanted behaviors.

Some implementations may include a system for generating a voltage reference, including a feedback path coupled to a first power rail; an output transistor having a gate coupled to the feedback path and to a second power rail through a resistance, a source coupled to the first power rail, and a drain coupled to a voltage reference; and a feedback transistor having a gate coupled to the voltage reference and a drain coupled to the feedback path, in which the output transistor operates as switch during a first time to connect the first power rail to the voltage reference, then operates in saturation during a second time to regulate the voltage reference to a target voltage based on the feedback path driving the gate of the output transistor.

Some implementations may include a method for generating a voltage reference, including operating an output transistor as switch during a first time to connect a first power rail to a voltage reference, in which the output transistor has a gate coupled to a feedback path and to a second power rail through a resistance, a source coupled to the first power rail, and a drain coupled to a voltage reference, and in which a feedback transistor has a gate coupled the voltage reference and a drain coupled to the feedback path; and operating the output transistor in saturation during a second time to regulate the voltage reference to a target voltage based on the feedback path driving the gate of the output transistor. Other aspects are also described and claimed.

The above summary does not include an exhaustive list of all aspects of the present disclosure. It is contemplated that the disclosure includes all systems and methods that can be practiced from all suitable combinations of the various aspects summarized above, as well as those disclosed in the Detailed Description below and particularly pointed out in the Claims section. Such combinations may have particular advantages not specifically recited in the above summary.

### BRIEF DESCRIPTION OF THE DRAWINGS

Several aspects of the disclosure here are illustrated by way of example and not by way of limitation in the figures of the accompanying drawings in which like references indicate similar elements. It should be noted that references to “an” or “one” aspect in this disclosure are not necessarily to the same aspect, and they mean at least one. Also, in the interest of conciseness and reducing the total number of figures, a given figure may be used to illustrate the features of more than one aspect of the disclosure, and not all elements in the figure may be required for a given aspect.

FIG. 1 is an example of a system for generating voltage references.

FIG. 2 is an example of a self-biased voltage reference generator referred to a lower power rail.

FIG. 3 is an example of a timing diagram for generating a voltage reference referred to a lower power rail.

FIG. 4 is a detailed view of the timing diagram of FIG. 3.

FIG. 5 is an example of a self-biased voltage reference generator referred to a higher power rail.

FIG. 6 is an example of a self-biased voltage reference generator in which a feedback path includes a cascode current mirror.

FIG. 7 is an example of a self-biased voltage reference generator in which a current source is included.

FIG. 8 is an example of a self-biased voltage reference generator in which multiple voltage references are generated at the same time.

FIG. 9 is an example of a process for generating voltage references.

### DETAILED DESCRIPTION

In electronic systems, it may be important for reference voltages to be available to system circuitry as early as possible. This may enable the system circuitry to achieve full operation and become available sooner for use. However, voltage generators typically rely on the availability of a power supply to generate voltage references. While a power supply is ramping up or down during a startup phase, a voltage reference might not be reliably available to the system circuitry. This may cause operation of the system circuitry to be delayed, and in some cases, unwanted behaviors to occur.

Implementations of this disclosure address problems such as these by switching an output transistor to clamp a power rail to a voltage reference upon start up to enable the voltage reference to quickly ramp with the power rail, then utilizing a feedback path to bias the output transistor in saturation to clamp the voltage reference to a target voltage. In some implementations, a system for generating a voltage reference may include a feedback path (e.g., a current mirror) coupled to a first power rail (e.g., VDD), a reference circuit coupled to a second power rail (e.g., VSS), an output transistor, and a feedback transistor. The output transistor may operate as switch during a first time (e.g., corresponding to the first power rail ramping up or down) to connect the first power rail to the voltage reference. The output transistor may then operate in saturation during a second time (e.g., corresponding to the first power rail exceeding a target voltage) to regulate the voltage reference to the target voltage set by the reference circuit. The output transistor may operate to regulate the voltage reference to the target voltage during the second time based on feedback to the feedback path driving the gate of the output transistor via a resistance coupled to the second power rail. As a result, the voltage reference may be available sooner to system circuitry, including at a lower voltage level of the power rail than in previous systems, to avoid delays to start system circuitry and/or to avoid unwanted behaviors. Other aspects are also described and claimed.

As described herein, a transistor may operate either as a switch or in saturation (two modes of operation). As a switch, the transistor may operate in either a cutoff region (an off state) or a linear (triode) region (an on state). The off state may occur when the gate-source voltage, VGS, of the transistor is less than a gate-source threshold voltage, VTH, of the transistor. In the off state, there is no current flow between the drain and source. This may represent a digital 0 in some systems. The on state may occur when the gate-source voltage VGS of the transistor is greater than the gate-source threshold voltage VTH of the transistor, and the drain-source voltage, VDS, of the transistor is less than VGS−VTH. In the on state, the drain and source of the transistor may function as a low drain-source resistance, RDS, path enabling a current to flow between the drain and source. This may represent a digital 1 in some systems. For example, a metal oxide semiconductor field effect transistor (MOSFET) may be used as a switch in digital and power electronics. In saturation, the transistor may operate based on biasing to allow a drain-source current to flow in a controllable manner. Saturation may occur when the gate-source voltage VGS of the transistor is greater than the gate-source threshold voltage VTH of the transistor, and the drain-source voltage VDS of the transistor is greater than VGS−VTH. For example, a MOSFET may be used in saturation in analog and amplifier applications.

In various embodiments, description is made with reference to figures. However, certain embodiments may be practiced without one or more of these specific details, or in combination with other known methods and configurations. In the following description, numerous specific details are set forth, such as specific configurations, dimensions, processes, etc., to provide a thorough understanding of the embodiments. In other instances, well-known semiconductor processes and manufacturing techniques have not been described in particular detail in order to not unnecessarily obscure the embodiments. Reference throughout this specification to “one embodiment” means that a particular feature, structure, configuration, or characteristic described in connection with the embodiment is included in at least one embodiment. Thus, the appearances of the phrase “in one embodiment” in various places throughout this specification are not necessarily referring to the same embodiment. Furthermore, the particular features, structures, configurations, or characteristics may be combined in any suitable manner in one or more embodiments.

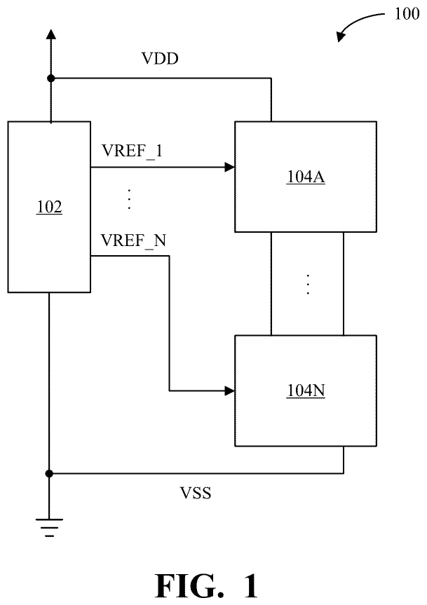

FIG. 1 is an example of a system 100 for generating voltage references. The system 100 may include a self-biased voltage reference generator 102 and system circuitry, such as system loads 104A to 104N where N is an integer greater than one. For example, the system loads 104A to 104N may include voltage regulators, power supplies, battery chargers, etc. The generator 102 may utilize a first power rail (e.g., VDD) and a second power rail (e.g., VSS) to generate one or more voltage references to be utilized by the one or more system loads. For example, the generator 102 may generate voltage reference VREF_1 to be utilized by system load 104A, and voltage reference VREF_N to be utilized by system load 104N. The generator 102 may utilize complementary metal oxide semiconductor (CMOS) technology to generate the voltage references, including MOSFETs, such as p-type MOSFETs (referred to as PMOS devices) and n-type MOSFETs (referred to as NMOS devices).

Each voltage reference may be fixed to a constant voltage level, which may be the same as or different than other voltage references. For example, voltage reference VREF_1 may be fixed to a lower voltage level and voltage reference VREF_N may be fixed to a higher voltage level. In another example, voltage reference VREF_1 and voltage reference VREF_N may be fixed to the same voltage level. Further, each voltage reference may be generated relative to either a higher power rail (e.g., a positive power source, such as VDD, ramping up) or a lower power rail or ground (e.g., a negative power source or ground, such as VSS, ramping down). For example, when a positive power source and a negative power source are available, voltage reference VREF_1 may be fixed to a positive voltage level and voltage reference VREF_N may be fixed to a negative voltage level. The voltage references may be used by the system loads 104A to 104N to bias circuitry in the system, including to enable operation of system circuitry, such as logic gates of functional blocks of an SoC.

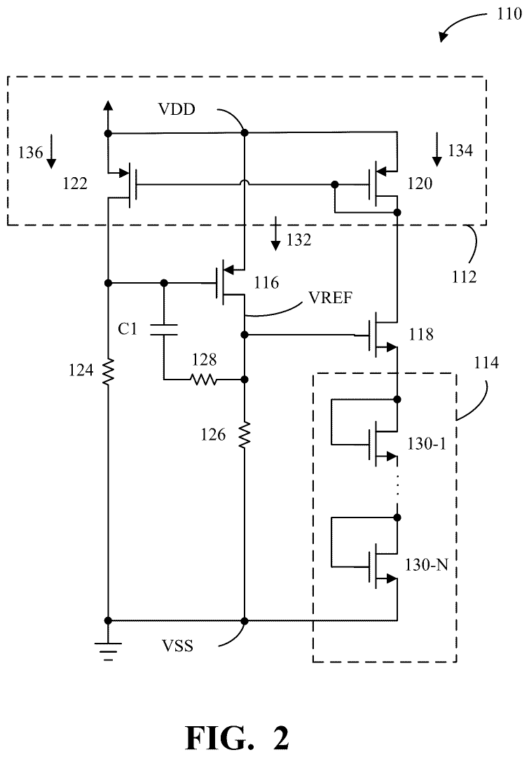

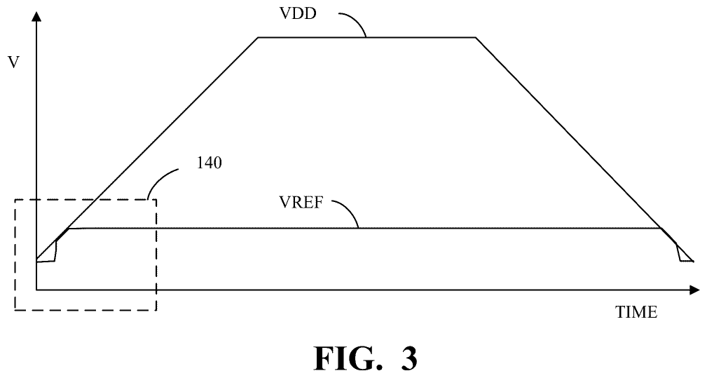

FIG. 2 is an example of a self-biased voltage reference generator 110 that generates a voltage reference, VREF, referred to a higher power rail. For example, the generator 102 of FIG. 1 may include circuitry of the generator 110 to generate a voltage reference, e.g., VREF_1. The generator 110 may include a feedback path 112, a reference circuit 114, an output transistor 116, a feedback transistor 118, and/or other discrete components. The generator 110 may generate the voltage reference VREF relative to a first power rail, VDD, being a positive power rail with a second power rail, VSS, being fixed to a constant voltage level or ground. FIG. 3 is an example of generating the voltage reference VREF relative to the first power rail VDD ramping up then ramping down. In this polarity/configuration, the output transistor 116 and transistors of the feedback path 112 may be PMOS devices, and the feedback transistor 118 and transistors configured as one or more diodes of the reference circuit 114 may be an NMOS device.

The feedback path 112 may be coupled to the first power rail VDD. In some implementations, the feedback path 112 may include transistors 120 and 122 (e.g., PMOS devices) forming a current mirror. For example, transistor 120 may be a connected as a diode, having its drain connected to its gate, and transistors 120 and 122 may each have their sources coupled to the first power rail VDD and their gates coupled to one another. The feedback path 112 may also be coupled to the reference circuit 114, via feedback transistor 118, to receive feedback indicating a target voltage set by the reference circuit 114. For example, transistor 120 may have a drain coupled to a drain of feedback transistor 118 (and coupled to a gate of transistor 122 in the current mirror) which in turn is coupled to the reference circuit 114.

The feedback path 112 may also be coupled to a gate of the output transistor 116 and coupled to the second power rail VSS through a resistance 124 (e.g., a first resistor) to bias the output transistor 116 to generate the voltage reference VREF. For example, transistor 122 may have a drain coupled to a gate of output transistor 116 and coupled to the second power rail VSS through the resistance 124. Thus, the feedback path 112 may create a negative loop to receive the target voltage and bias the output transistor 116 to generate the voltage reference VREF. A capacitor C1 and a resistance 128 (e.g., a second resistor) in series, coupled between the gate and drain of the output transistor 116, may implement a Miller compensation branch to stabilize the loop.

The reference circuit 114 may be coupled between the feedback transistor 118 and the second power rail VSS. The reference circuit 114 may be utilized to set the target voltage for the voltage reference VREF. The reference circuit 114 may include one or more transistors, each connected as diodes (e.g., having a drain connected to a gate). For example, the reference circuit 114 may include transistor 130-1 (having its gate and drain connected to a source of feedback transistor 118), transistor 130-N (having its gate and drain connected to a source of feedback transistor 130-1), and so forth, where N is an integer greater than one. A sum of gate-source voltage drops, VGS, produced by the transistors configured as diodes may set the target voltage.

The output transistor 116 may produce the voltage reference VREF at its drain. The output transistor 116 may have a gate coupled to the feedback path 112 and coupled to the second power rail VSS through the resistance 124, a source coupled to the first power rail VDD and a drain coupled to a gate of the feedback transistor 118 and coupled to the second power rail VSS through a resistance 126 (e.g., a third resistor). The output transistor 116 may operate as either a switch to connect the first power rail VDD to the voltage reference VREF, or in saturation to regulate the voltage reference VREF to the target voltage set by the reference circuit 114. The output transistor 116 may operate as a switch during a first time (e.g., corresponding to the first power rail VDD ramping up) to connect the first power rail to the voltage reference, or in saturation during a second time (e.g., corresponding to the first power rail exceeding a target voltage) to regulate the voltage reference to the target voltage set by the reference circuit 114. The output transistor 116 may operate as a switch or in saturation based on the voltage level of the first power rail VDD (e.g., whether VDD is above or below the target voltage).

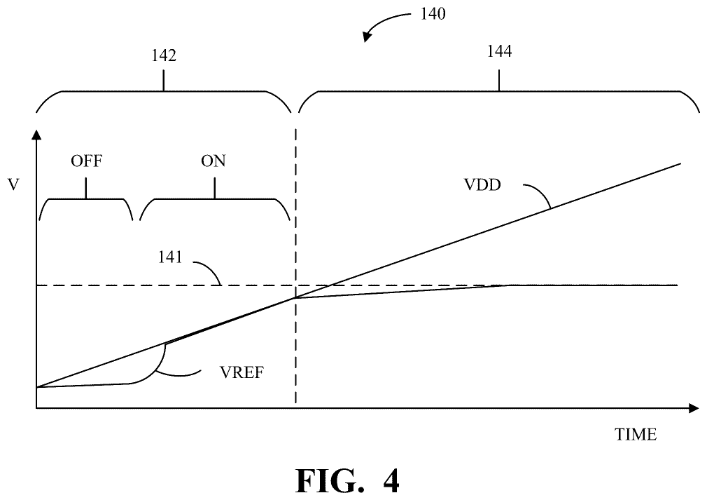

By way of example, FIG. 4 shows a detailed view 140 of FIG. 3 in which the first power rail VDD is ramping up. The output transistor 116 may operate either as a switch during a first time 142 or in saturation during a second time 144. Additionally, during the first time 142, the output transistor 116 may be in an off state then may transition to an on state before operating in saturation during the second time 144. Specifically, during the first time 142 in which the first power rail VDD is at a lowest voltage level, e.g., initially ramping from zero volts, the output transistor 116 may operate as a switch in the off state in which no current conducts from source to drain. The off state may be maintained by the gate of the output transistor 116 being pulled to the second power rail VSS through the resistance 126, while the first power rail VDD is below a threshold of the gate-source voltage, VGS, of the output transistor 116 (e.g., the first power rail VDD being close to zero volts). Then, as the first power rail VDD continues to ramp up, the output transistor 116 may transition to the on state when the first power rail VDD exceeds the threshold of the gate-source voltage VGS of the output transistor 116. The on state may cause the output transistor 116 to clamp the first power rail VDD to the voltage reference VREF with current 132 conducting from drain to source. This clamping enables the voltage reference VREF to quickly ramp with the first power rail VDD upon start up.

Then, during the second time 144 in which the first power rail VDD exceeds the threshold of the gate-source voltage VGS of the output transistor 116, e.g., continuing to ramp to a steady state of VDD, the output transistor 116 may be biased in saturation by the feedback path 112. This biasing regulates the voltage reference VREF to a target voltage 141 set by the reference circuit 114 based on feedback. Specifically, in the feedback path 112, a current 134 conducting from source to drain of transistor 120 (and through transistors 118, 130-1, and 130-N of the branch) may be mirrored as a current 136 conducting from source to drain of transistor 122. The current 136, generated by a voltage drop produced by the resistance 124, may be driven to the gate of the output transistor 116 to bias that transistor. Biasing the output transistor 116 causes the current 132 conducting from source to drain of the output transistor 116, generated by a voltage drop produced by the resistance 126, to generate the voltage reference VREF at its drain and to drive the gate of the feedback transistor 118 to bias that transistor. Biasing the feedback transistor 118 in turn adjusts the current 134 to regulate the voltage reference VREF to the target voltage set by the reference circuit 114. Specifically, when the voltage reference VREF reaches a value that equals the target voltage set by the sum of gate-source thresholds of the reference circuit 114, the current 134 will be produced and mirrored to current 136 to control the gate of the output transistor 116 in saturation to clamp the voltage reference VREF to the target voltage.

Thus, a closed loop created by the feedback path 112 biases the output transistor 116 to maintain the voltage reference VREF at the target voltage to keep the voltage reference VREF constant as the first power rail VDD ramps to its maximum voltage level. Further, variations of the voltage reference VREF, caused by variations of the first power rail VDD, may be attenuated by the loop created by the feedback path 112 during operation (e.g., to provide stability of the voltage reference VREF). This may enable the generator 110 to improve a power supply rejection ratio (e.g., a measure of stability of the voltage reference VREF with power supply variations), particularly at low frequency. As a result, the voltage reference VREF may be available sooner to system circuitry, such as the system loads 104A to 104N, to provide power to downstream circuitry.

In some implementations, the first power rail VDD may be a high voltage supply. In this case, transistors 116, 120, and 122 may be high voltage transistors capable of withstanding the first power rail VDD across their source-drain terminals. However, transistors 118, 130-1, and 130-N may be low voltage transistors which do not need to withstand the first power rail VDD across their source-drain terminals. C1 may also be a low voltage capacitor that does not need to withstanding the first power rail VDD across its terminals.

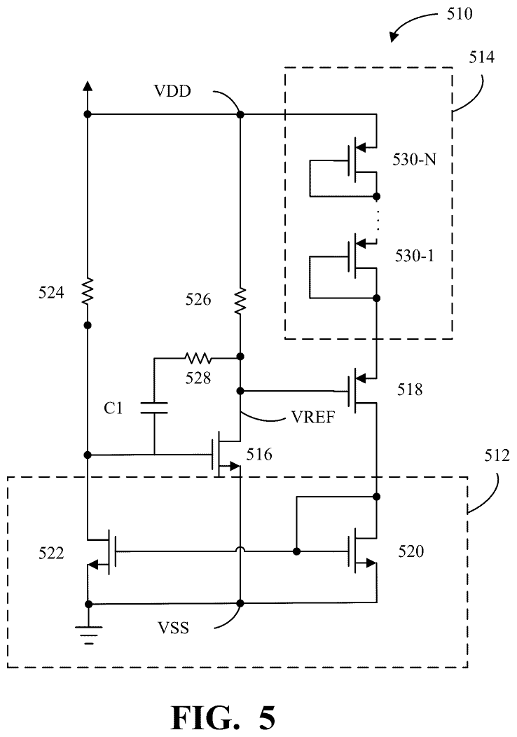

As discussed above with respect to FIG. 1, a voltage reference may be generated relative to either a higher power rail or a lower power rail or ground. FIG. 2 is an example of the generator 110 generating a voltage reference VREF relative to a lower power rail, e.g., the second power rail VSS, while a higher power rail, e.g., the first power rail VDD, is ramping up. The generator 110 generates the voltage reference VREF having a fixed delta above the lower power rail, e.g., the second power rail VSS, such as ground. When feedback is active in the system (e.g., output transistor 116 is in saturation), the generator 110 maintains the reference voltage VREF at a constant delta with respect to the lower rail (e.g., VSS) regardless of the higher rail voltage (e.g., VDD). FIG. 5 is an example of a self-biased voltage reference generator 510 that generates a voltage reference, VREF, relative to a higher power rail, e.g., the first power rail VDD (e.g., an opposite polarity of the generator 110 of FIG. 2). The generator 510 in FIG. 5 generates a voltage having a fixed delta below the first power rail VDD. When feedback is active in the system (e.g., output transistor 516 is in saturation), the generator 110 maintains the reference voltage VREF at a constant delta with respect to the higher rail (e.g., VDD) regardless of the lower rail voltage (e.g., VSS). The generator 102 of FIG. 1 may include circuitry of the generator 510 to generate a voltage reference, e.g., VREF_N.

Similar to the generator 110, the generator 510 may include a feedback path 512, a reference circuit 514, an output transistor 516, a feedback transistor 518, and/or other discrete components. The generator 510 may generate the voltage reference VREF relative to the second power rail VSS being a negative power rail or ground with a first power rail VDD being fixed to a constant voltage level. For example, this may be an inverse of the timing diagram of FIG. 3. In this polarity/configuration, the output transistor 516 and transistors of the feedback path 512 may be NMOS devices, and the feedback transistor 518 and transistors configured as the reference circuit 514 may be an PMOS device.

The feedback path 512 may be coupled to the second power rail VSS. In some implementations, the feedback path 512 may include transistors 520 and 522 (e.g., NMOS devices) forming a current mirror. For example, transistor 520 may be a connected as a diode, having its drain connected to its gate, and transistors 520 and 522 may each have their sources coupled to the second power rail VSS and their gates coupled to one another. The feedback path 512 may also be coupled to the reference circuit 514, via feedback transistor 518, to receive feedback indicating a target voltage set by the reference circuit 514. For example, transistor 520 may have a drain coupled to a drain of feedback transistor 518 (and coupled to a gate of transistor 522 in the current mirror).

The feedback path 512 may also be coupled to a gate of the output transistor 516, and coupled to the first power rail VDD, through a resistance 524 (e.g., a first resistor), to bias the output transistor 516 to generate the voltage reference VREF. For example, transistor 522 may have a drain coupled to a gate of output transistor 516 and coupled to the first power rail VDD through the resistance 524. Thus, the feedback path 512 may create a positive loop to receive the target voltage and bias the output transistor 516 to generate the voltage reference VREF. A capacitor C1 and a resistance 528 (e.g., a second resistor) in series, coupled between the gate and drain of the output transistor 516, may implement a Miller compensation branch to stabilize the loop.

The reference circuit 514 may be coupled between the feedback transistor 518 and the first power rail VDD. The reference circuit 514 may be utilized to set the target voltage for the voltage reference VREF. The reference circuit 514 may include one or more transistors each connected as diodes (e.g., having a drain connected to a gate). For example, the reference circuit 514 may include transistor 530-1 (having its gate and drain connected to a source of feedback transistor 518), transistor 530-N (having its gate and drain connected to a source of transistor 530-1), and so forth, where N is an integer greater than one. A sum of gate-source voltage drops, VGS, produced by the transistors configured as diodes may set the target voltage.

The output transistor 516 may produce the voltage reference VREF at its drain. The output transistor 516 may have a gate coupled to the feedback path 512 and coupled to the first power rail VDD through the resistance 524, a source coupled to the second power rail VSS and a drain coupled to a gate of the feedback transistor 518 and coupled to the second power rail VDD through a resistance 526 (e.g., a third resistor). The output transistor 516 may operate as either a switch to connect the second power rail VDD to the voltage reference VREF, or in saturation to regulate the voltage reference VREF to the target voltage set by the reference circuit 514. The output transistor 516 may operate as a switch during a first time (e.g., corresponding to the second power rail VSS ramping down) to connect the second power rail to the voltage reference VREF, or in saturation during a second time (e.g., corresponding to the second power rail VSS below a target voltage) to regulate the voltage reference VREF to the target voltage set by the reference circuit 514. The output transistor 516 may operate as a switch or in saturation based on the voltage level of the second power rail VDD (e.g., whether VSS is above or below the target voltage).

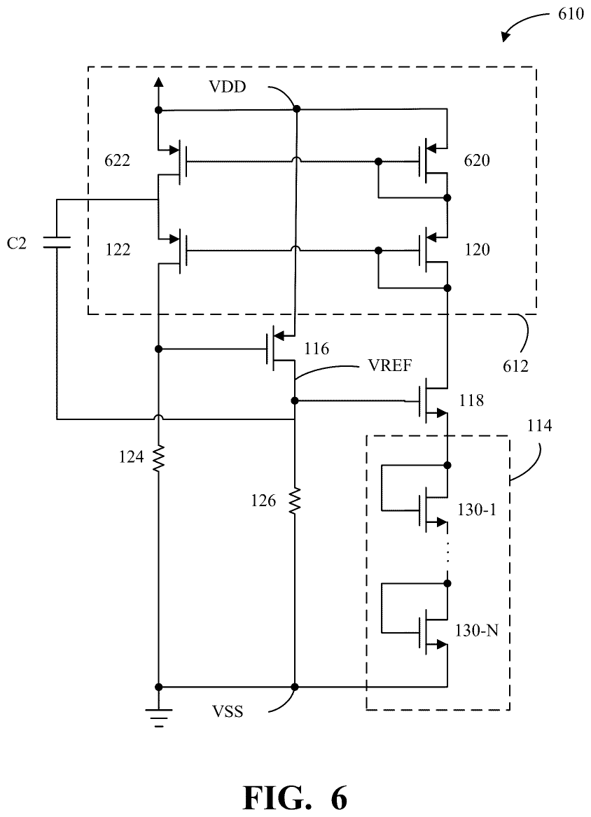

As discussed above with respect to FIG. 2, variations of the voltage reference VREF, caused by variations of the first power rail VDD, may be attenuated by the loop created by the feedback path during operation to ensure the voltage reference VREF remains fixed to the constant voltage level. In some cases, variations of the voltage reference VREF may be attenuated further by utilizing a feedback path that includes a cascode current mirror (e.g., to provide even greater stability of the voltage reference VREF). FIG. 6 is an example of a self-biased voltage reference generator 610 in which a feedback path 612 includes a cascode current mirror. For example, the generator 102 of FIG. 1 may include circuitry of the generator 610 to generate a voltage reference, e.g., VREF_1. The generator 610 may include the feedback path 612, as well as the reference circuit 114, the output transistor 116, the feedback transistor 118, and/or other discrete components of the generator 110. The generator 610 may generate a voltage reference VREF, which may be relative to the first power rail VDD like the generator 110 (or relative to the second power rail VSS with circuitry of the generator 510).

The feedback path 612 may be coupled to the first power rail VDD. In addition to transistors 120 and 122 of the feedback path 112, the feedback path 612 may include transistors 620 and 622 (e.g., PMOS devices) forming a second current mirror. For example, transistor 620 may be a connected as a diode, having its drain connected to its gate, and transistors 620 and 622 may each have their sources coupled to the first power rail VDD and their gates coupled to one another. In a modification of the feedback path 112, a drain of transistor 620 may be connected to the source of transistor 120, and a drain of transistor 622 may be connected to the source of transistor 122 (instead of sources of transistors 120 and 122 coupled to the first power rail VDD). The second current mirror, formed by transistors 620 and 622, increases the gain of the loop and as a result increases attenuation of variations of the voltage reference, caused by variations of the first power rail VDD, to provide even greater stability of the voltage reference VREF. A capacitor C2, coupled between transistors 622 and 122 on a first side, and coupled to a drain of output transistor 116 on a second side, may implement an Ahuja compensation branch to stabilize the loop.

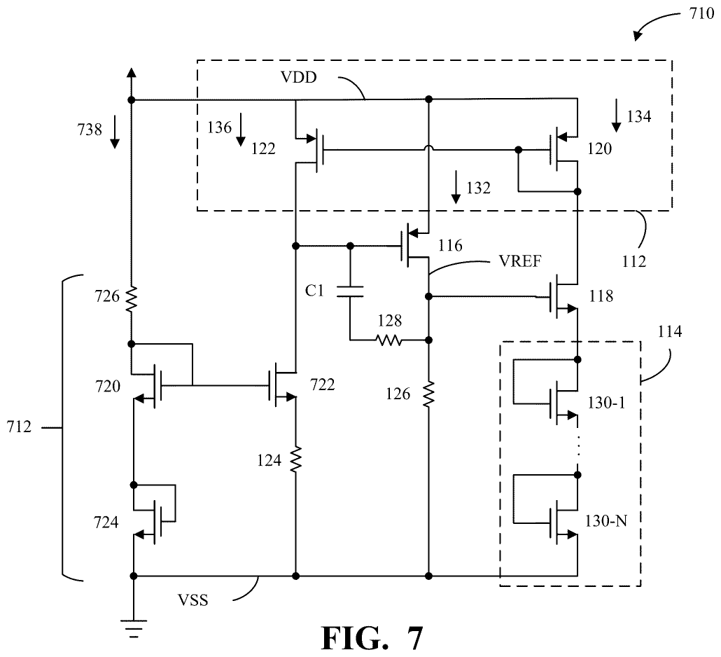

In some implementations, a current source may be coupled to the feedback path to regulate the voltage reference to the target voltage. This may further improve stability of the loop. FIG. 7 is an example of a self-biased voltage reference generator 710 in which a current source 712 is included. For example, the generator 102 of FIG. 1 may include circuitry of the generator 710 to generate a voltage reference, e.g., VREF_1. In the generator 710, the current source 712 may be coupled to the feedback path 112 to form an additional branch. For example, the additional branch may include a resistance 726 (e.g., a fourth resistor) coupled to the first power rail VDD, a second current mirror formed by transistors 720 and 722 (e.g., NMOS devices) coupled to the resistance 726, and a transistor 724 (e.g., another NMOS device) coupled to the second current mirror and coupled to the second power rail VSS. In the second current mirror, transistor 720 may be a connected as a diode, having its drain connected to its gate, and transistors 720 and 722 may each have their gates coupled to one another. The source of transistor 720 may be coupled to the drain of transistor 724. The source of transistor 722 may be coupled to the resistance 124, and the drain of transistor 722 may be coupled to the feedback path 112 (e.g., the drain of transistor 122). The gate and drain of transistor 724 may be coupled to the source of transistor 720, and the source of transistor 724 may be coupled to the second power rail VSS. A current 738 generated by the current source 712 may be mirrored as current 136 in the feedback path 112. This may reduce the dependence of current 132 on the first power rail VDD and in turn further improve a power supply rejection ratio, including based on current 134 flowing though the reference circuit 114 now depending less on first power rail VDD (e.g., a square root of VDD).

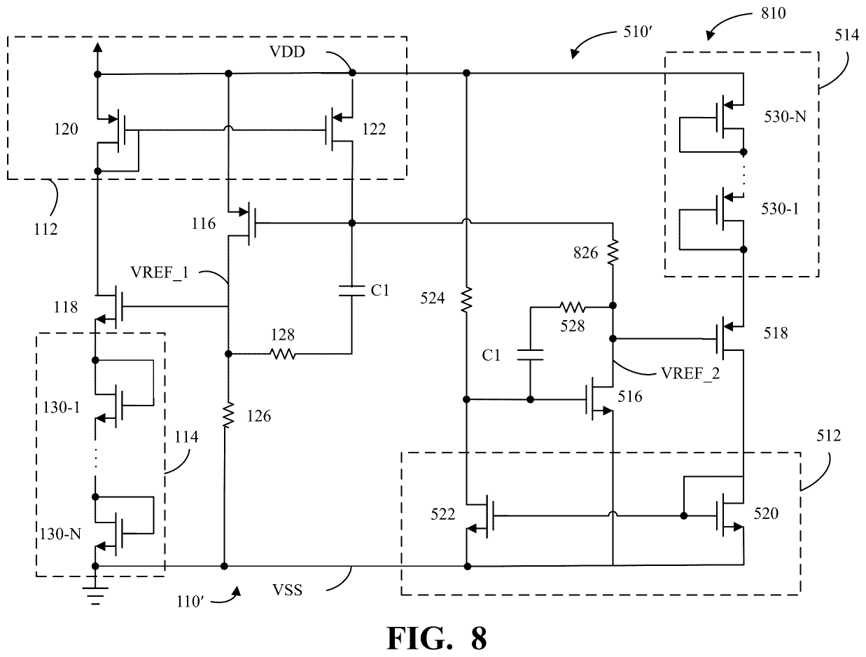

In some implementations, multiple self-biased voltage reference generators may be combined to generate multiple voltage references. This may reduce current consumption and/or further improve the power supply rejection ratio, particularly relative to the second power rail VSS. FIG. 8 is an example of a self-biased voltage reference generator 810 in which multiple voltage references are generated at the same time, e.g., VREF_1 and VREF_2. For example, the generator 102 of FIG. 1 may include circuitry of the generator 810 to generate multiple voltage references, e.g., VREF_1 and VREF_N. In the generator 810, a generator 110′ comprising a variation of the generator 110 of FIG. 2 (drawn as a mirror image of FIG. 1) may be coupled to a generator 510′ comprising a variation of the generator 510 of FIG. 5 (e.g., first and second generators of opposite polarity). Specifically, a drain of output transistor 516 may be coupled to a gate of output transistor 116 through a resistance 826 and coupled to the feedback path 112. The feedback path 112 may be coupled to the gate of the output transistor 116, to bias the output transistor 116 to generate the voltage reference VREF_1, and the feedback path 512 may be coupled to the gate of the output transistor 516 to bias the output transistor 516 to generate the voltage reference VREF_2. This may reduce current consumption and/or further improve the power supply rejection ratio.

Reference is now made to flowcharts of examples of processes for generating voltage references in systems. The processes can be executed using computing devices, such as the systems, hardware, and software described with respect to FIGS. 1-8. The processes can be performed, for example, by executing a machine-readable program or other computer-executable instructions, such as routines, instructions, programs, or other code. The operations of the processes or other techniques, methods, or algorithms described in connection with the implementations disclosed herein can be implemented directly in hardware, firmware, software executed by hardware, circuitry, or a combination thereof.

For simplicity of explanation, the processes are depicted and described herein as a series of operations. However, the operations in accordance with this disclosure can occur in various orders and/or concurrently. Additionally, other operations not presented and described herein may be used. Furthermore, not all illustrated operations may be required to implement a process in accordance with the disclosed subject matter.

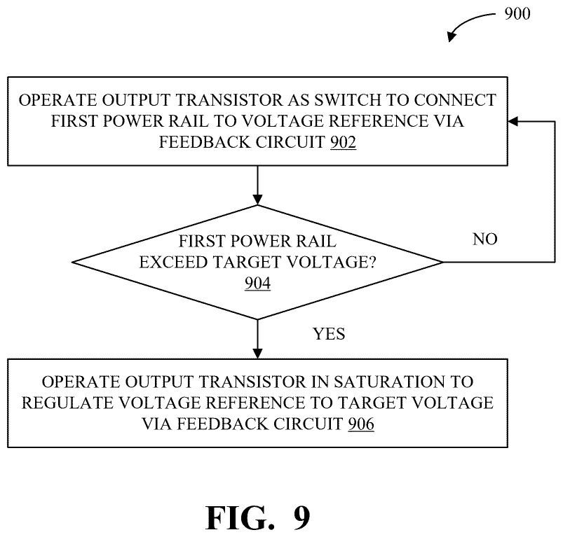

FIG. 9 is an example of a process 900 for generating a voltage reference (e.g., VREF_1, VREF_2, or VREF_N). A self-biased voltage reference generator may include a feedback path coupled to a first power rail (e.g., VDD), a reference circuit coupled to a second power rail (e.g., VSS), an output transistor, and a feedback transistor. At operation 902, the generator may operate the output transistor as switch during a first time to connect a first power rail to a voltage reference. The output transistor may have a gate coupled to a feedback path and to a second power rail through a resistance, a source coupled to the first power rail, and a drain coupled to a voltage reference. The feedback transistor may have a gate coupled to the voltage reference, a source coupled to the reference circuit, and a drain coupled to the feedback path. The reference circuit may set a target voltage. The first time may correspond to the first power rail ramping up or down.

At operation 904, if the first power rail does not exceed the target voltage (e.g., has not yet ramped above the target voltage) (No), the generator may continue to operate the output transistor as switch during the first time as the first power rail is ramping. However, at operation 904, if the first power rail does exceed the target voltage (Yes), at operation 906 the generator may operate the output transistor in saturation during a second time to regulate the voltage reference to the target voltage set by the reference circuit. The generator may operate the output transistor in saturation based on the feedback path driving the gate of the output transistor. The second time may correspond to the first power rail exceeding the target voltage. Additionally, the generator may attenuate variations of the voltage reference, caused by variations of the first power rail, by a loop created by the feedback path.

The generator may provide the voltage reference to bias system circuitry, including during a startup phase. For example, the system circuitry may include voltage regulators, power supplies, battery chargers, etc. The system circuitry may enable operation of logic gates of functional blocks.

As used herein, the term “circuitry” refers to an arrangement of electronic components (e.g., transistors, resistors, capacitors, and/or inductors) that is structured to implement one or more functions. For example, a circuit may include one or more transistors interconnected to form logic gates that collectively implement a logical function.

In utilizing the various aspects of the embodiments, it would become apparent to one skilled in the art that combinations or variations of the above embodiments are possible for self-biased voltage reference generators. Although the embodiments have been described in language specific to structural features and/or methodological acts, it is to be understood that the appended claims are not necessarily limited to the specific features or acts described. The specific features and acts disclosed are instead to be understood as embodiments of the claims useful for illustration.

What is claimed is:

1. A system for generating a voltage reference, comprising:
a feedback path coupled to a first power rail;
an output transistor having a gate coupled to the feedback path and to a second power rail through a resistance, a source coupled to the first power rail, and a drain coupled to a voltage reference; and
a feedback transistor having a gate coupled to the voltage reference and a drain coupled to the feedback path,
wherein the output transistor operates as switch during a first time to connect the first power rail to the voltage reference, then operates in saturation during a second time to regulate the voltage reference to a target voltage based on the feedback path driving the gate of the output transistor.

2. The system of claim 1, wherein the first time corresponds to the first power rail ramping up or down, and wherein the second time corresponds to the first power rail exceeding the target voltage.

3. The system of claim 1, wherein variations of the voltage reference, caused by variations of the first power rail, are attenuated by a loop created by the feedback path.

4. The system of claim 1, further comprising:
a reference circuit coupled between the feedback transistor and the second power rail, wherein the target voltage is set by the reference circuit and the output transistor.

5. The system of claim 4, wherein the reference circuit comprise a plurality of transistors connected as diodes.

6. The system of claim 1, wherein the feedback path includes a current mirror.

7. The system of claim 6, wherein the current mirror includes a first transistor and a second transistor, each having their sources coupled to the first power rail and their gates coupled to one another.

8. The system of claim 6, wherein the current mirror includes a first transistor and a second transistor, the first transistor having a drain coupled to the feedback transistor and to a gate of the second transistor, and the second transistor having a drain coupled to the second power rail through the resistance and to the gate of the output transistor.

9. The system of claim 1, wherein the first power rail is a positive power rail, the output transistor is a PMOS transistor, and the feedback transistor is an NMOS transistor.

10. The system of claim 1, wherein the first power rail is a negative power rail or ground, the output transistor is an NMOS transistor, and the feedback transistor is a PMOS transistor.

11. The system of claim 1, wherein the feedback path includes a cascode current mirror.

12. The system of claim 1, further comprising:
a current source coupled to the gate of the output transistor and to the second power rail.

13. The system of claim 1, further comprising:
a second output transistor having a gate coupled to a second feedback path and to the first power rail through a second resistance, a source coupled to the second power rail, and a drain coupled to a second voltage reference; and
a second feedback transistor having a gate coupled to the second voltage reference and a drain coupled to the second feedback path.

14. The system of claim 13, wherein the gate of the output transistor is coupled to the second voltage reference through a third resistance.

15. The system of claim 1, wherein the voltage reference is utilized to bias system circuitry during a startup phase.

16. The system of claim 1, further comprising:
a resistor coupled between the drain of the output transistor and the second power rail.

17. The system of claim 1, further comprising:
a capacitor and a resistor in series, coupled between the gate and the drain of the output transistor, to stabilize a loop created by the feedback path.

18. A method for generating a voltage reference, comprising:
operating an output transistor as switch during a first time to connect a first power rail to a voltage reference, wherein the output transistor has a gate coupled to a feedback path and to a second power rail through a resistance, a source coupled to the first power rail, and a drain coupled to a voltage reference, and wherein a feedback transistor has a gate coupled the voltage reference and a drain coupled to the feedback path; and
operating the output transistor in saturation during a second time to regulate the voltage reference to a target voltage based on the feedback path driving the gate of the output transistor.

19. The method of claim 18, wherein the first time corresponds to the first power rail ramping up or down, and wherein the second time corresponds to the first power rail exceeding the target voltage.

20. The method of claim 18, further comprising:
supplying the voltage reference to bias system circuitry during a startup phase.
